(19) United States
(12) Patent Application Publication
(10) Pub. No.: US 2025/0145413 A1
(43) Pub. Date: May 8, 2025

(54) BRAKE CATCHING DEVICE

(71) Applicant: Cobianchi Liftteile AG, Oberdiessbach (CH)

(72) Inventors: Hermann GEHRIG, Aeschi (CH); Rudolf RAMSEIER, Teuffenthal (CH)

(73) Assignee: Cobianchi Liftteile AG, Oberdiessbach (CH)

(21) Appl. No.: 18/835,457

(22) PCT Filed: Feb. 2, 2023
(86) PCT No.: PCT/EP2023/052562

§ 371 Date: Aug. 2, 2024

(30) Foreign Application Priority Data
Feb. 4, 2022 (AT) A50060/2022
Dec. 13, 2022 (EP) 22213209.4

(51) Int. Cl. B66B 5/18

(52) U.S. Cl. CPC B66B 5/18

(57) ABSTRACT

In a safety brake device for a conveying device, such as an elevator cabin and/or a counterweight, a brake shoe is applied at a rail parallel to the conveying route when the safety brake device is triggered. An engagement lever on the rail side opposite the brake shoe is pivotable between release and brake positions. In the brake position, the rail is clamped between lever and shoe. A trigger element deflects the engagement lever to the brake position. To that end, the trigger element is displaceable from a release position to a brake position. A roller is displaceable from a release position remote from the rail to a first brake position in contact with the rail and then further, parallel to the rail, to a second brake position, in which the contact element acts upon the trigger element. An electrically triggerable actuation arrangement controls the displacement of the roller.

### CROSS REFERENCE TO RELATED APPLICATIONS

This application is the National Stage of PCT/EP2023/052562 filed on Feb. 2, 2023, which claims priority under 35 U.S.C. § 119 of European Application No. 22213209.4 filed on Dec. 13, 2022 and Austrian Application No. A50060/2022 filed Feb. 4, 2022, the disclosures of which are incorporated by reference. The international application under PCT article 21(2) was not published in English.

### BACKGROUND OF THE INVENTION

### 1. Field of the Invention

The invention relates to a safety brake device for a conveying means, in particular for an elevator cabin and/or for a counterweight.

### 2. Description of the Related Arts

It is an object of safety brake devices to stop a conveying means that travels at an excessive speed. They must be able to stop the conveying means loaded with the rated load out of free fall, wherein a range is fixed for the delay to be achieved. Most of the known safety brake devices have brake shoes which are applied at a rail oriented in the conveying direction, for example a guide rail for an elevator cabin. In the known safety brake devices, the brake shoes are moved by eccentrics, wedges or rockers.

EP 1283189 A1 describes a device with a support element to be affixed to the conveying means and at least one brake shoe affixed thereto so as to be movable, which is intended to be applied at a rail arranged in a stationary manner parallel to the conveying route when the safety brake device is triggered. To that end, the brake shoe is movable at least approximately at a right angle to the conveying route. Further, an engagement lever is provided, which is arranged on the side of the rail opposite the brake shoe and is pivotable about a first axis oriented transversely to the rail between a release position and at least one brake position, wherein the rail, in the brake position, is clamped between the end of the engagement lever and the brake shoe. A trigger lever, which is pivotable about a second axis oriented transversely to the rail between a release position and at least one brake position, is coupled to the engagement lever such that, in each brake position of the trigger lever, also the engagement lever is in a brake position. This safety brake device has a simpler structure and smaller dimensions than known safety brake devices with a comparable braking effect.

The safety brake device of EP 1733992 A1 consists of a brake unit and a trigger unit. The brake unit consists of a first brake shoe and of a triangular, rotatable support with other brake shoes. A trigger arm, which is applied at the rotatable support and brings it in brake position, is held in release position until triggering takes place by means of a mechanical bolt. For the triggering of the device, the mechanical bolt can be released by means of an electromagnetic actuator actively controlled to that end, whereupon the trigger arm is pushed to the guide rail by a coaxial compression spring, a frictional connection with the guide rail is generated there and the trigger arm is twisted due to the frictional connection, whereby also the support is twisted to the brake position. The rotational movement and the retreating of the brake shoes at the support result in the first brake shoe being guided to the guide rail and creating the required brake force.

EP 1439144 A2 discloses a safety brake device for an elevator system, having a catching device connected to the elevator cabin, which converts a relative movement of an actuating element extending along the guide rail for the elevator cabin to a braking force acting between catching device and guide rail, which braking force causes the vehicle to brake. The braking operation is activated via a speed limiter. The braking device further comprises an electromechanical trigger device, which is equipped with a brake acting electromechanically upon the guide rail and which is movable relative to the elevator cabin on the guide rail. The trigger device is coupled to the catching device by means of the actuation element such that a relative movement between vehicle and trigger device is converted to a relative movement of the actuation element and to a braking application of the catching device at the guide rail.

As disclosed in EP 3153451 A1, a trigger device for such a safety brake device can comprise, for example, a pivotably mounted trigger lever which is connectable to the safety brake device and is intended to be applied at a rail arranged in a stationary manner parallel to a conveying route, wherein the trigger lever is also displaceably mounted and loaded with a clamping force acting in a displacement direction. In a release position, the trigger lever is held in this release position by a hydraulically created retaining force counteracting the clamping force, wherein the trigger lever is movable from the release position to a clamping position by deactivation of the retaining force, in which clamping position the safety brake device is actuated during further relative movement of trigger device and guide rail. A fluidic actuator is provided, which acts upon the trigger element against the pretension force via a controllable source for the working fluid.

DE 202022100179 U1 discloses a safety brake device for an elevator cabin having a support element affixed at the elevator cabin and comprising a brake arrangement for a clamping engagement with the guide rail for the elevator cabin. Also here, a trigger arrangement having a trigger element that is displaceable parallel to the braking direction is provided, which trigger arrangement is connected, in terms of control engineering, to the brake arrangement in order to bring same to the brake position. The trigger arrangement has a clamping roller, which is displaceable from a release position to a brake position resting against the guide rail and, during further relative movement of elevator cabin and guide rail, rolls further, essentially parallel to the braking direction, to a second brake position. Here, a force in a direction towards the brake position of the trigger element acts upon the trigger element. An electrically triggerable actuation arrangement prevents and/or causes the movement of the contact roller in the first brake position, i.e. for contact with the guide rail. The trigger arrangement comprises a trigger clamping surface oriented parallel to the braking direction and towards the guide rail, which trigger clamping surface moves together with a clamping roller transversely to the direction of movement of the elevator in a direction of the guide rail. This trigger clamping surface is adjoined, on both sides and viewed in both directions of movement, by main clamping surfaces, which are anchored on the trigger base body separately from the trigger clamping surface, and are not moved with the clamping roller. These main clamping surfaces are spring-mounted and located essentially also parallel to the guide rail and to the trigger clamping surface. The trigger clamping surface and the main clamping surfaces are arranged and designed such that the clamping roller rolls beyond each end of the trigger clamping surface into the gap between a main clamping surface and the guide rail, irrespective of whether an upwards or a downwards movement is currently executed. The trigger clamping surface is mounted at one end of the lever, upon whose other end acts an electrically activatable actuation arrangement having a controllable electromagnet, which holds the clamping roller in the release position against the pretension force.

### SUMMARY OF THE INVENTION

It was an object of the present invention to specify a device by means of which safety brake devices can be triggered, preferably electrically, with the highest reliability.

This object is achieved by means of a device in accordance with one aspect of the invention.

These known devices must be supplied with current in a neutral state in order to maintain the trigger element in its passive position. As this current consumption is to cease during longer or intentional interruptions of the operation of the conveying means, the current is interrupted here, which leads to an abrupt and hard transition to the active position with the trigger element stopping at the end position. This results in a loud noise, and, in case of frequent execution, there is also the risk of damage to the plant.

It is therefore another object of the present invention to improve devices mentioned in the beginning in order to reduce the noise emission upon deactivation of the safety brake device and ensure a soft, material-protecting deactivation.

This other object is achieved by means of a device in accordance with another aspect of the invention.

Starting point of the invention is a safety brake device for a conveying means, in particular for an elevator cabin and/or for a counterweight, having a support element to be affixed at the conveying means at least with the brake arrangement and with a free space, which, in an installed state of the safety brake device, receives a rail arranged in a stationary manner parallel to the conveying route, wherein the brake arrangement is designed to clamp the rail located in the free space in the brake position and, to that end, is equipped with at least one brake shoe affixed at the support element, with a braking surface extending in braking direction, which is intended to be applied at a rail arranged in a stationary manner parallel to the conveying route when the safety brake device is triggered, wherein the brake shoe is movable approximately at a right angle to the braking surface. An engagement element is arranged on the side of the free space opposite the brake shoe and is placeable between a release position and at least one brake position, wherein the shortest distance between the engagement element and the brake shoe is provided in the brake position. Further, a trigger arrangement is provided which is connected, in terms of control engineering, to the brake arrangement in order to bring same to a brake position. Here, a trigger element is coupled to the engagement element such that same is deflected to at least one brake position.

Here, the trigger arrangement typically comprises a trigger element, which is displaceable parallel to the braking direction from a release position to at least one brake position and coupled to the brake arrangement such that same can also be brought to a brake position; and the trigger arrangement has a contact element which is displaceable from a release position to a first brake position maximally protruding into the free space, wherein the contact element is displaceable further, essentially parallel to the braking direction to a second brake position, in which it exerts a force on the trigger element in a direction towards the brake position of the trigger element, and an electrically triggerable actuation arrangement prevents or causes the movement of the contact element to the first brake position. Here, the braking direction is the direction along which the brake shoe moves along the rail received in the free space during the braking operation. Here, the braking direction is typically parallel to the braking surface, transverse to the direction of motion of the brake shoe when pressed against the rail and is identical to the course of the rail received in the free space This permits, in a simple manner, a basis for the evaluation of a switching operation of the safety brake device from a passive, basic state to the triggered, active state, which switching operation is electrically controlled by acceleration, velocity or weight sensors.

The trigger element is preferably equipped with a guide running in its longitudinal direction, preferably in the form of an oblong hole, for the contact element or for the connection to the engagement element.

The device in accordance with the invention is characterized in that the actuator acts upon a counterholder displaceable transversely to the braking direction and in relation to the free space, which counterholder is equipped with a guide contour for the contact element. Here, it is particularly advantageous for the effect of the contact element, which increases in the course of the braking operation, if the guide, preferably the rolling contour, has at least one section whose distance from the rail declines consistently from the release position towards the brake position. Preferably, the guide can extend even further, and another section, whose distance to the rail corresponds to at least that of the release position, can adjoin from the section closest to the free space towards the brake position.

Here, an embodiment is preferred in which the contact element is configured as a roller affixed to an axle, in particular having a friction-increasing rolling circumference. To increase the frictional connection to the rail and thus guarantee optimal functioning when applied at the rail, the roller can be configured as a toothed roller or can be knurled or equipped with coatings and/or layers having a high coefficient of friction at the rolling circumference. Preferably, the roller is configured hardened and wear-resistant. Some of these precautions are expedient also in differently configured contact elements.

A preferred solution for such a guide is a progressive rolling contour arranged in the counterholder for a contact element designed as a roller. This ensures a gentle coupling of the trigger arrangement to the rail with subsequent progressive action upon the brake arrangement. This can make sure, among other things, that the catching device is only actuated once the maximum drive force of the toothed roller is built up.

In accordance with the invention, the contact element is preferably acted upon with a pretension force in a direction towards the free space by means of at least one actuator. Here, in the basic position, in which the safety brake device is inactive, the electrically activatable actuation arrangement counteracts the pretension force and thereby holds the contact element in the release position.

To that end, a first, structurally simple and functionally reliable embodiment of and in accordance with the invention provides a compression spring as actuator, wherein the contact element is acted upon with the pretension force by means of at least one compression spring.

A functionally reliable electric triggering of the safety brake device of the invention is possible by means of an actuation arrangement which has a controllable electromagnet that acts upon the contact element against the pretension force when supplied with current.

An alternative solution is characterized in that the actuation arrangement has at least one fluidic actuator, which acts upon the contact element against the pretension force via a controllable source for the working fluid.

Further, also an embodiment can be provided in which the actuation arrangement, when supplied with current by means of a fluidic, electric or electromagnetic actuator, acts upon the contact element with a force in a direction towards the trigger position.

Another embodiment of the invention is characterized in that the trigger arrangement is positioned at a base body of the brake arrangement and mounted so as to be displaceable transversely to the braking direction with the base body. This ensures that fewer mistakes can occur during installation, as the positioning of the trigger device in relation to the free space and to the brake arrangement for the respective safety brake device is definite.

To achieve the other object, the device is characterized by a controller for the actuation arrangement, which is designed to move the trigger element to the trigger position upon manual input or in accordance with a specifiable schedule while the actuation arrangement is active and to then deactivate the power supply of the actuation arrangement, and to subsequently reactivate the power supply of the actuation arrangement until a new manual input takes place, or in accordance with the specifiable schedule, and to move the trigger element to the passive position again.

Here, the actuation arrangement preferably has a controllable electromagnet, which acts upon the trigger element against the pretension force when supplied with current. This ensures a good holding force with simple control and triggering.

In order to ensure a particularly quiet switching to the deactivated state that protects the material of the device by gentle motion sequences, the controller for the actuation arrangement is designed so as to move the trigger element, in case of a manual input or in accordance with a specifiable schedule, to the trigger position more slowly than in an emergency.

In accordance with a preferred embodiment of the invention, the actuation arrangement has an electric rotary motor, which acts upon the trigger element in order to move same between passive position and trigger position.

Particularly simple to control and operate is an embodiment in accordance with the invention in which the rotary motor is designed to move in one direction of rotation only.

In order to ensure a particularly quiet switching to the deactivated state that protects the material of the device by means of gentle motion sequences, the rotary motor is advantageously operated with lower rpm in case of a manual input or in accordance with a specifiable schedule than after an emergency.

### BRIEF DESCRIPTION OF THE DRAWINGS

For the purpose of better understanding of the invention, it will be elucidated in more detail by means of the figures below.

The figures show in a respectively very simplified schematic representation:

FIG. 1 a safety brake device in accordance with the invention in the deactivated basic or initial position in a perspective view;

FIG. 2 the safety brake device of FIG. 1 viewed from the direction opposite of FIG. 1;

FIG. 3 the safety brake device of FIG. 1 in basic position in a direct side view;

FIG. 4 the safety brake device of FIG. 1 in a lateral view viewed from the direction opposite of FIG. 1;

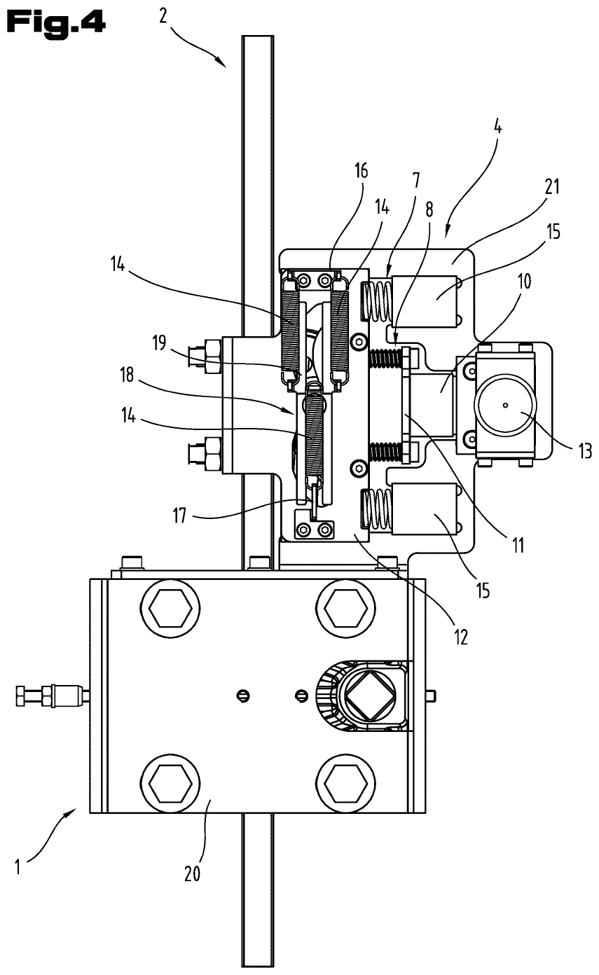

FIG. 5 the safety brake device of FIG. 1 in an activated state at the start of the braking operation;

FIG. 6 the safety brake device of FIG. 1 in an intermediate position during the braking operation during downward movement;

FIG. 7 the safety brake device of FIG. 1 in the end position for the braking operation during downward movement;

FIG. 8 another embodiment of a safety brake device in accordance with the invention in a perspective view corresponding to FIG. 2;

FIG. 9 a schematic circuit diagram for the control of the safety brake devices of FIGS. 1 to 8.

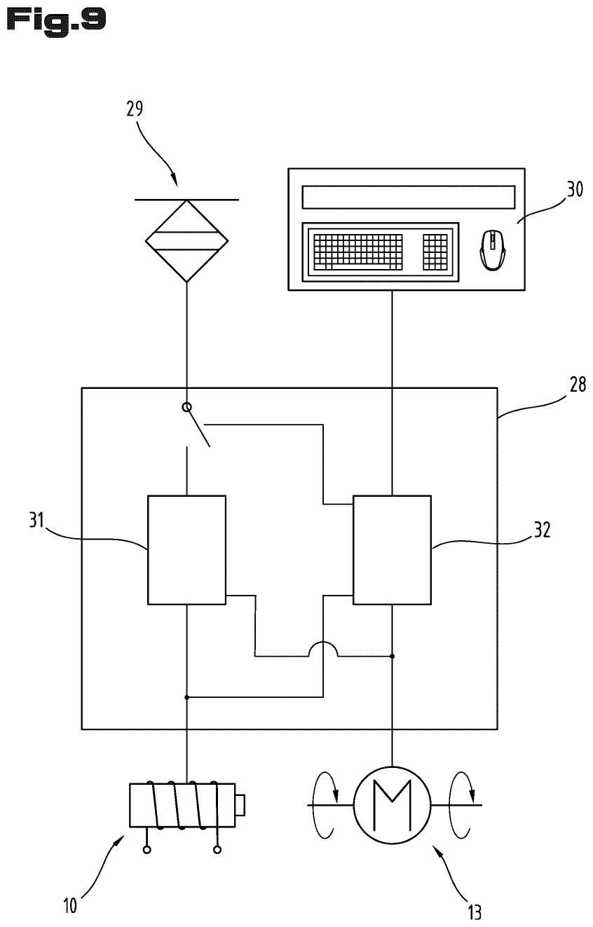

### DETAILED DESCRIPTION OF PREFERRED EMBODIMENTS

First of all, it is to be noted that, in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure, and in case of a change of position, these specifications of location are to be analogously transferred to the new position.

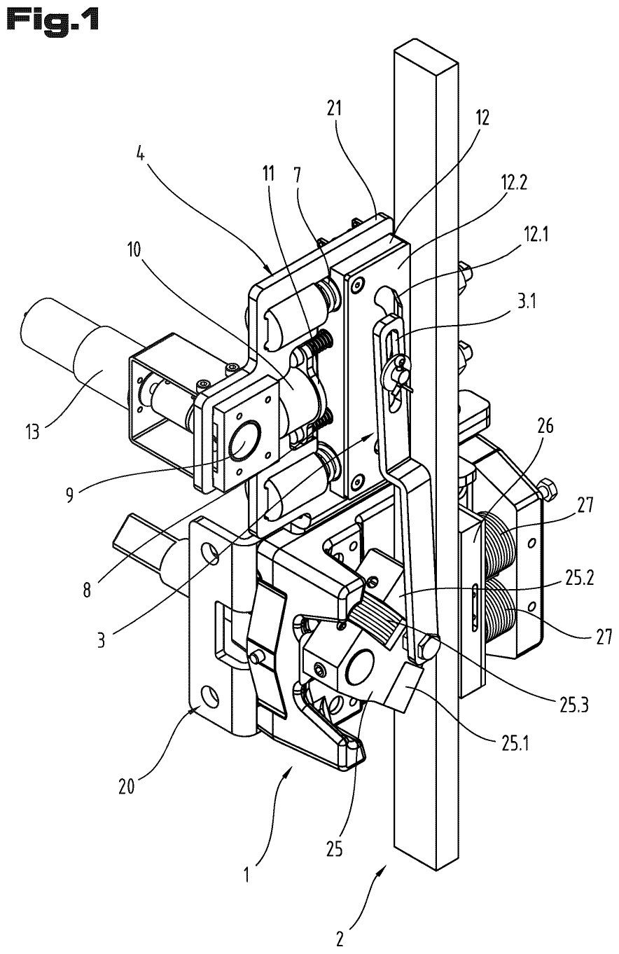

FIG. 1 shows an embodiment of a safety brake device 1 in accordance with the invention for a conveying means. It is in particular intended for an elevator cabin or also for its counterweight, which is connected to the elevator cabin via ropes, belts or suchlike. Within the scope of the present description and claims and due to their close functional connection, both elements are summarized under the term conveying means.

The exemplary embodiment of a safety brake device explained in more detail in the description below and represented in the drawing figures is equipped with electric triggering by an electrically actuated holding magnet 10.

Here, a support element 20 of the safety brake device 1, at which at least one brake shoe 26 is attached, is affixable to the conveying means. After the brake device is triggered, the brake shoe 20 is finally applied at a rail 2 of the conveying means to achieve the braking effect, which rail 2 extends parallel to the route of the conveying means when the conveying means and the support element 20 move further relative and parallel to the rail 18. The brake shoe 26 preferably has braking surface, which extends in braking direction, which typically runs parallel to the extension of the rail 2. This rail 2 can be formed by a part of the arrangement for operating the conveying means that is provided anyway, for example a guide, for example of an elevator cabin. If such a guide or similar element is not suitable to interact with the safety brake device 1 in accordance with the invention, a rail 2 designed thereto can be installed independently and be integrated in the system also in addition to the conveying means being equipped with the safety brake device 1, but it is nevertheless not a part of the safety brake device 1 in accordance with the invention. Within the scope of the invention, the term “rail” is understood to mean all such elements at which the safety brake device 1 in accordance with the invention can be applied.

Here, the brake shoe 26, which is preferably supported via packages of disc springs 27 and preferably also displaceable parallel to the rail 2 by a small distance, is movable at least approximately transversely to the braking surface and thus also essentially at a right angle to the conveying route and to the rail 2. The movement of the brake shoe 26 towards the rail 2 is caused by an engagement element 25 affixed to the support element 20, which engagement element 25 is arranged at a distance on the side opposite the braking surface of the brake shoe 26, with the rail 2 passing between the brake shoe 26 and the engagement element 25. Here, the engagement element 25 is pivotable between a release position and at least one brake position.

Between the brake shoe 26 and the engagement element 25, a free space is defined, which, in the installed state of the safety brake device 1, receives the rail 2 arranged in a stationary manner parallel to the conveying route. In the passive position of the safety brake device 1, the rail 2 can be guided through the free space unimpeded. In the braking state, at least the elements of the brake arrangement having a braking effect protrude so far into this free space that the rail 2 is clamped and fixed between these elements, in particular between the brake shoe 26 and the engagement element 25.

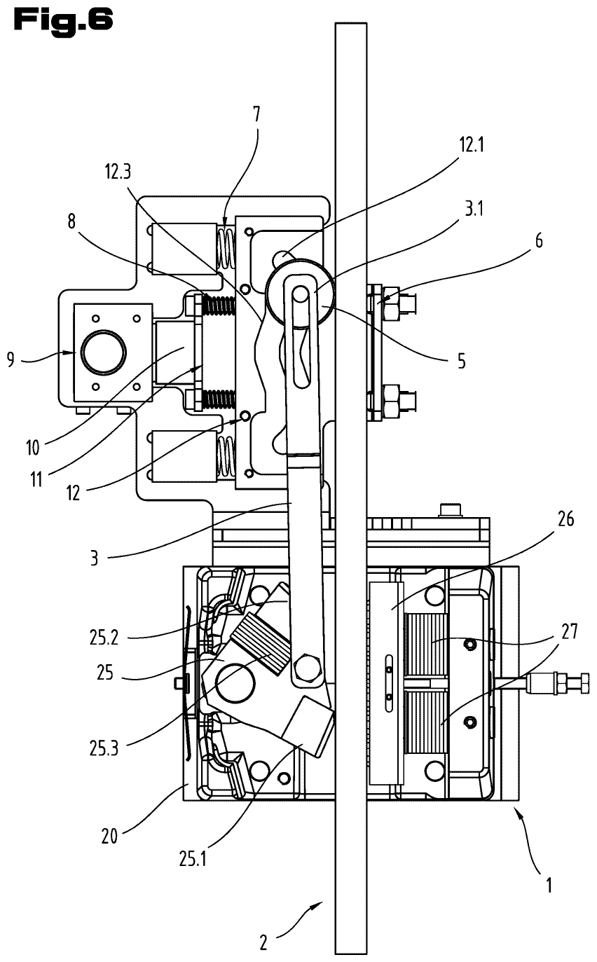

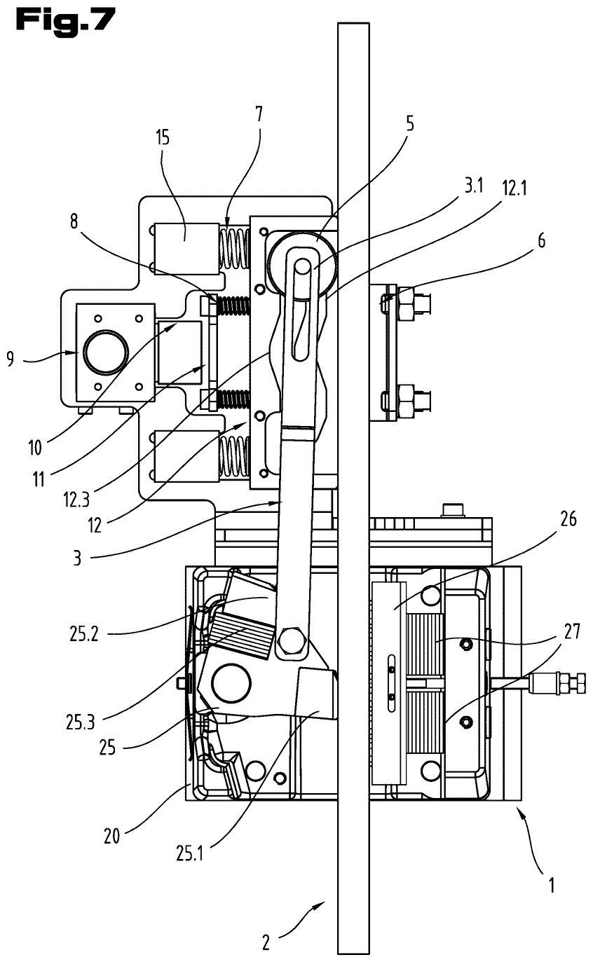

Preferably, the engagement element is configured as an engagement lever 25 that is fork-shaped or V-shaped and has two heads 25.1 and 25.2 and is pivotable between a release position (FIG. 1, 3) and at least one brake position (FIG. 7 as an example of the downward catch) as the furthest deflected end position. The heads 25.1 and 25.2 are designed to protrude respectively into the free space after a first, slight pivoting of the engagement element 25 in any direction and finally be applied at the rail 2 (as shown in the intermediate position of FIG. 6) and, due to the friction at the rail, 2 pivot the engagement lever 25 completely to the furthest deflected brake position (the FIG. 7). While the exemplary embodiment represented is double-acting, i.e. enables a safety braking operation in both directions of movement of the conveying means along the rail 2, also merely single-acting embodiments are possible which offer either only the upward catch or only the downward catch. Here, an engagement lever with only one head is sufficient.

In this respective brake position, the rail 2 is clamped between the respective end of the engagement element 25 and the brake shoe 26, and the conveying means equipped with the support element 20 is braked and fixed in a stationary manner in relation to the rail 2. Of course, also embodiments with two separate engagement elements 25 are possible in order to have one independent lever each for both directions of motion of the conveying means along the rail 2. Also, at least one of the heads of at least one engagement lever, preferably the head 25.2 effective for the upward catch, for example of the V-shaped engagement lever 25, can be supported at the lever body via disc springs 25.3.

A trigger element 3 is hinged, preferably so as to be pivotable, at the engagement element 25 and connects the engagement element to the trigger arrangement 4 of the safety brake device in accordance with the invention. The elements and modules of the trigger arrangement 4 are mounted on an attachment plate 21 and/or connected thereto, which attachment plate 21 is affixed at the support element 20, on which at least the brake shoe 26 and the engagement element 25 are attached.

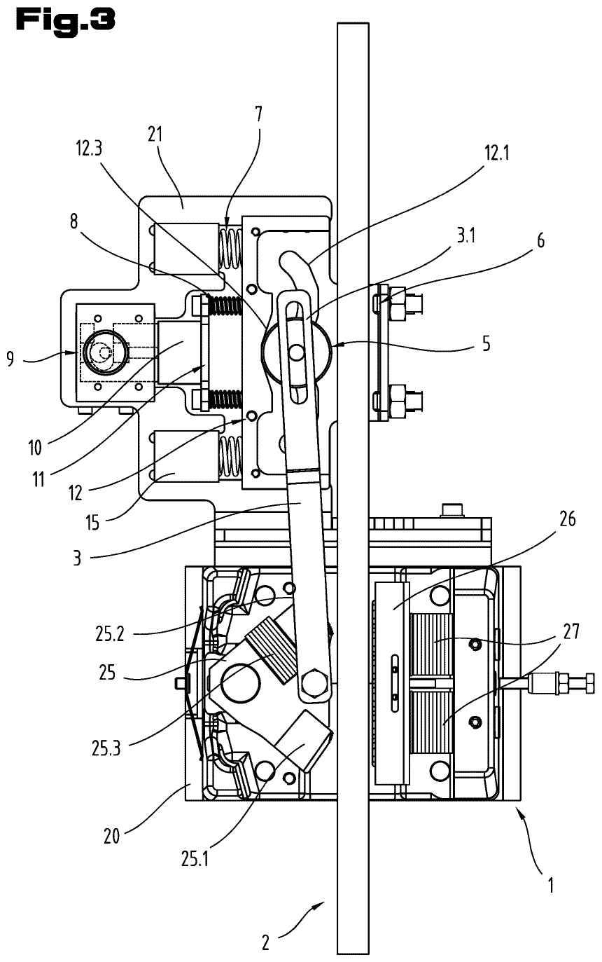

In the exemplary embodiment represented, the trigger unit 4 comprises a roller as contact element 5, which is received and held in a counterholder 12, which, in turn, is affixed in or at the attachment plate 21 so as to be displaceable transversely to the rail 2. The interior space of the counterholder 12 receiving the roller 5 is closed by a cover metal sheet 12.2 (represented in FIG. 1, removed in FIGS. 3 and 5 to 7).

In the trigger element 3, the contact element 5 is guided in a guide, which is also preferably formed by an oblong hole 3.1. In the embodiment represented, the axle of the roller 5 is displaceable in the oblong hole 3.1, in the longitudinal extension of same. This oblong hole 3.1 is arranged at the end of the trigger element 3 opposite the engagement element 25 and has the effect that relative differences in speed can be compensated for. The same effect can be achieved with an alternative embodiment in which the connection of the trigger element 3 to the engagement element 25 is displaceable in a longitudinal direction of the trigger element 3. A connection element at the engagement element 25 could be received and guided, for example, in a guide, preferably an oblong hole at the end opposite the contact element 5.

A braking element 6 is arranged at the counterholder 12 on the opposite side relative to the rail 2, which braking element 26—in this context, see in particular FIG. 3—is pressed against the rail 2 by the effect of the contact element 5 transversely away from the rail 22 when the counterholder 12 is displaced. This braking element 6 is adjustable at a distance to the rail 2 and equipped with a wear-resistant coating or a corresponding brake pad. Corresponding radii at the peripheries prevent damage to the rail during the gliding along the rail 2. Together with the counterholder 12 and/or the contact element 5, the braking element 6 defines another free space of the trigger arrangement, which is offset relative to the free space of the brake arrangement in the braking direction and/or along the rail 2.

At least one arrangement for applying a force acting in a direction of the rail 2 to the counterholder 12, and thus also for applying a force acting in a direction of the rail 22 to the roller 5, is provided at the counterholder 12, preferably formed by two compression springs 7, preferably respectively in a spring guide 15 that prevents buckling. These compression springs 7 apply a defined force to the counterholder 12 with the roller 5 in a direction towards the rail 2. Yet, also embodiments in which the contact element 5 is acted upon directly by the force towards the rail 2 could be provided. Finally, the counterholder 12 is also provided with a coupler plate 11, which is connected via a connection arrangement that is preferably adjustable lengthwise, which connection arrangement permits an approach of the coupler plate 11 to the counterholder 12 against the effect of elastic elements, preferably compression springs 8, but limits the maximum distance of the coupler plate 11 from the counterholder 12, preferably so as to be adjustable, for example via mounting shoulder screws.

As can be seen in FIGS. 3 and 5 to 7, in which the normally provided cover metal sheet 12.2 is not marked, the counterholder 12 has a defined rolling contour 12.3 at its rear interior side opposite the free space for the rail 2. When acted upon by means of the compression springs 7, rolling contour 12.3 and contact element 5 are in contact and the counterholder 12 transfers the force of the compression springs 7 to the roller 5 via the rolling contour 12.3. The rolling contour 12.3 is configured so as to run progressively from its starting section, which is the central section here for the safety brake device 1 acting in both directions, towards the brake position of the contact element 5, so that, when the roller 5 moves along the rolling contour 12.3, the counterholder 12 is pushed away from the rail 2 passing the free space on the one hand and the roller 5, in contrast, is pushed more and more strongly towards the rail 2. Adjoining the end section of the rolling contour 12.3 that is closest to the rail 2 is a receiving region for the roller 5, which is now in its final brake position, in which the roller 5 can be received in order to allow for the counterholder 12 to approach the rail 2 again without further pressure against the rail 2 and to lift the braking element 6 from the rail 2 again in this process.

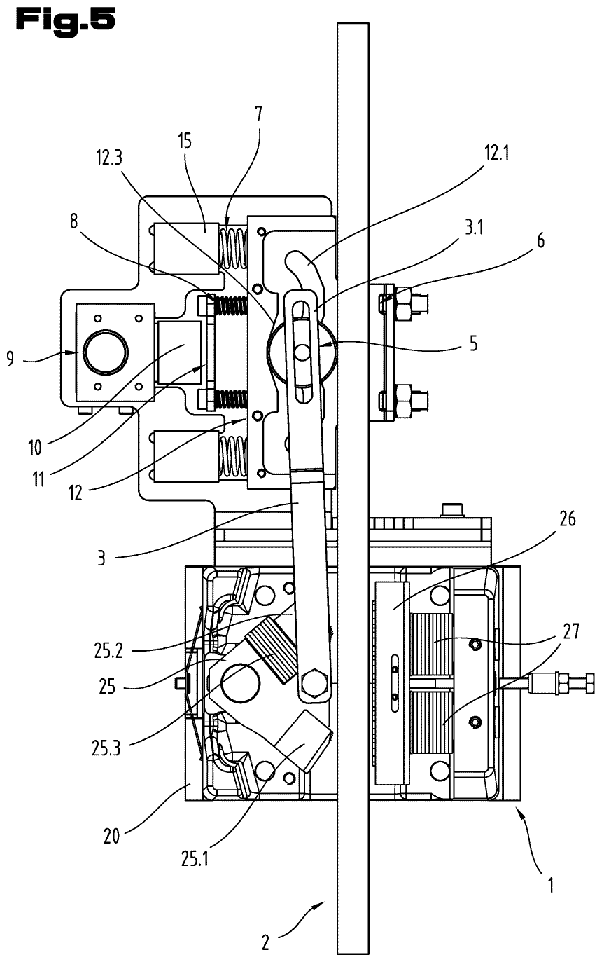

The axle of the roller 5 is guided in a curved oblong hole 12.1 in the counterholder 12 and also in the cover metal sheet 12.2 in order to enable the movement along the rolling contour 12.3 and to enable the counterholder 12 to first move away from the rail 2 received in the free space between the contact element 5 and the braking element 6 (see FIGS. 5 and 6) and move towards the free space again in the end position (FIG. 7). Therefore, also the oblong hole 12.1 has a course running parallel to the rolling contour 12.3 in its central section, and its end sections are subsequently configured curved in opposite directions.

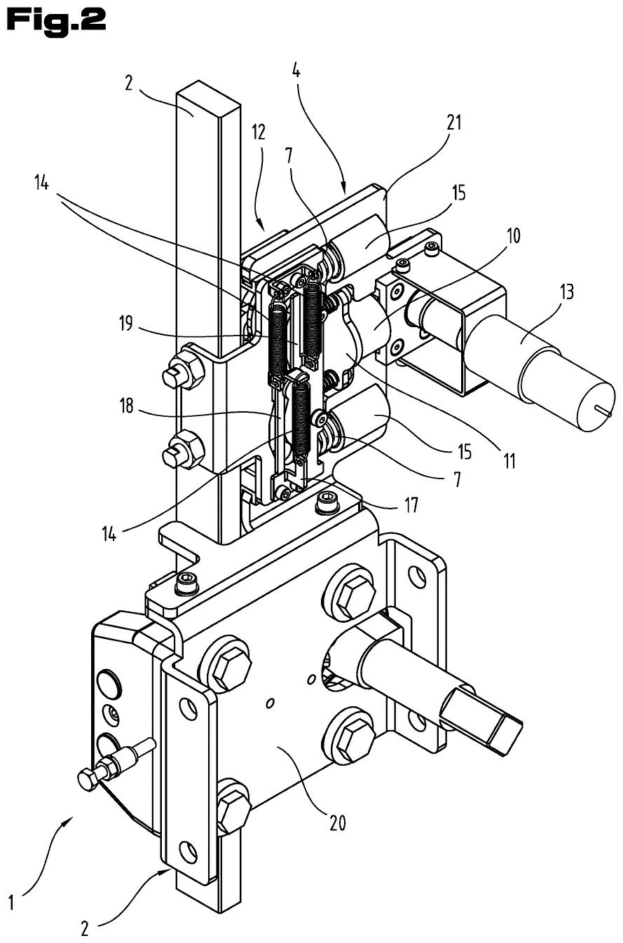

As can be readily seen in FIG. 2, the roller 5 is connected in a movable manner to the counterholder 12 with its axle such that the roller 25 is held centrally at the rolling contour 12.3 and in the oblong hole 12.1 in the basic state but can still be deflected upwards or downwards after the safety brake device 1 is triggered. To that end, the axle of the roller 5 is affixed in a lower retraction guide element 18, which is acted upon downwardly by an extension spring 14. The upper retraction guide element 19 acts upon the axle of the roller 5 from below and, to that end, is acted upon upwardly by the upper extension springs 14. In a non-active state of the safety brake device, the roller 5 is therefore held in a basic position in an equilibrium between the extension springs 14. The end of the extension springs 14 opposite the axle of the roller 5 is affixed at an upper spring holding element 16 and/or a lower spring holding element 17. The approximately U-shaped retraction guide elements 18, 19 must also follow the moving components transversely to the free space and the rail 2 and are therefore displaceable along the surface of the counterholder 12 transversely to its longitudinal extension. Here, the extension springs 14 have a centering effect also in this transverse direction to the oblong holes of the retraction guide elements 18, 19. In accordance with the invention, the retention effect on the contact element 5 is caused by an electrically controllable actuation arrangement, which is affixed and/or mounted on or at the attachment plate 21. This arrangement can be readily seen in FIGS. 1 and 2. In the embodiment represented in the drawing figures, an electronically controllable electromagnet 10, in particular a clamping magnet, is used to that end.

In the basic position of FIGS. 1 to 3 of the not-yet-triggered safety brake device, the electromagnet 10 is supplied with current, whereby a coupler plate 11 is held in the position closest to the electromagnet 10, preferably resting against it, by the magnetic force.

Preferably, the electromagnet 10 is coupled to an eccentric 9, which is located in a housing so as to be protected and can be actuated by a rotary motor 13, preferably a DC motor, preferably with a planetary gearbox. This arrangement ensures that the electromagnet 10 can be moved in alignment with or parallel to the movement of the roller 5 towards the rail 2 or away from it. This arrangement allows for a simple automatic resetting of the roller 5 and of the counterholder 12 to the basic position. When the rotary motor 13 is actuated, the electromagnet 10 is guided towards the coupler plate 11 and can cause the magnetic coupling again when supplied with current. The spring effect of the compression springs 8 between coupler plate 11 and counterholder 12 enables an approach of these two elements with a reliable docking, as peak forces can thus be sprung, should the electromagnet 10 by guided too far in the direction of the counterholder 12 by the eccentric 9. When the rotary motor 13 is actuated further, the coupler plate 11, the counterholder 12 and the contact element 5 and all other elements affixed thereto are guided away from the rail 2 back to the non-active basic position again via the eccentric 9.

Below, the essential stages of the triggering and braking operation are to be explained in more detail with reference, in particular, to FIGS. 3 and 5 to 7.

Starting from the basic position of FIG. 3 with the electromagnet 10 still supplied with current in the normal operation of the conveying means, which electromagnet 10 still holds the contact element 5, the counterholder 12 and the braking element 6 in the release position and in which thus also the trigger element 3 and the engagement element 25 coupled thereto remain in the release position, the safety brake device is triggered in the event of an incident, triggered by a sensor arrangement for the monitoring of the speed and/or the monitoring of the acceleration and/or the monitoring of the weight.

In this process, the application of current to the electromagnet 10 is stopped for the embodiment of the invention represented here, so that the counterholder 12, under the action of the compression springs 7, and also the contact element 5 itself, by the action of the rolling contour 12.3 upon the contact element 5, are moved in a direction towards the rail 2 until the contact element 5 finally rests against the rail 2 and enters into a frictional connection thereto. This results in the safety brake device 1 being in the activation position shown in FIG. 5. In this state of the safety brake device, the trigger element 3 has not yet been moved and the engagement element 25 has also not yet been deflected out of its release position.

Due to the frictional connection of the roller 5 to the rail 2, which can be optimized by designing the roller 5 as a toothed roller or also by processing and/or coating the rolling circumference differently for achieving a higher coefficient of friction, the contact element 5 is rolled between the rail 2 and the rolling contour 12.3 from the neutral position and/or release position between the extension springs 14 towards a brake position—i.e. upwards for the downward catch in FIG. 6—and deflected from its central position in this process. Here, the contact element 5 is displaced in the counterholder 12 along the rolling contour 12.3 and along the oblong hole 12.1 and moves to the end of the oblong hole 3.1 of the trigger element 3 as well, with counterholder 12 and brake arrangement 25, 26 leading. During further, slight relative movement of the conveying means equipped with the safety brake device 1, the contact element 5 comes into the section of the rolling contour 12.3 and of the oblong hole 12.1 closest to the rail 2, is thus firmly pressed against the rail 2 and finally pulls the trigger element 3 upwards by a first distance, further in the direction of a brake position, after reaching the upper end of its oblong hole 3.1. This causes a first, slight deflection of the engagement element 25 coupled to the trigger element 3 from its release position until the lower head 25.1 of the engagement element 25, that for the downward catch, enters into the free space between the engagement element 25 and the brake shoe 26, finally also rests against the rail 2 and enters into a frictional connection there, as shown in FIG. 6 by the representation of the limit position for the downward catch.

However, the movement of the roller 5 along the progressive rolling contour 12.3, simultaneously with the pressing of the roller 5 against the rail 2 as a reaction thereto, causes the displacement of the counterholder 12 away from the rail 2, against the action of the compression springs 7. Here, the braking element 6 is simultaneously pulled towards the rail 2, enters into a frictional connection to the rail 2 and supports the braking effect in this first braking phase of the downward catch.

During continued relative movement of the conveying means in relation to the rail 2, the engagement element 25 keeps pivoting further and further due to the frictional connection of the head 25.1 of the engagement lever 25 to the rail 2 until it finally arrives in the brake position represented in FIG. 7, its end position in the downward catch. In this process, it has its greatest press-on effect and simultaneously pulls the brake shoe 26 against the rail 2, so that the greatest braking effect is provided.

In the course of this pivoting of the engagement element 25, also the trigger element 3 is displaced further, opposite the movement of the safety brake device 1, i.e. upwards in FIG. 7, onto the trigger device 4 with the roller 5. This allows for the roller 5, which is still in a frictional connection to the rail 2, to also be moved somewhat further upwards. Here, the contact element 5 enters a region in the counterholder 12 whose distance from the rail 2 corresponds to at least the region of the rolling contour 12.3 against which the contact element 5 rests in the position at the start of the braking operation. The counterholder 12 can now approach the rail 2 again under the action of the compression springs 7 and the opposite braking element 6 is lifted up from the rail 2 again. The contact element 5 itself is no longer acted upon by a force towards the rail 2. The braking effect is now achieved solely via the engagement lever 25 and the brake shoe 26.

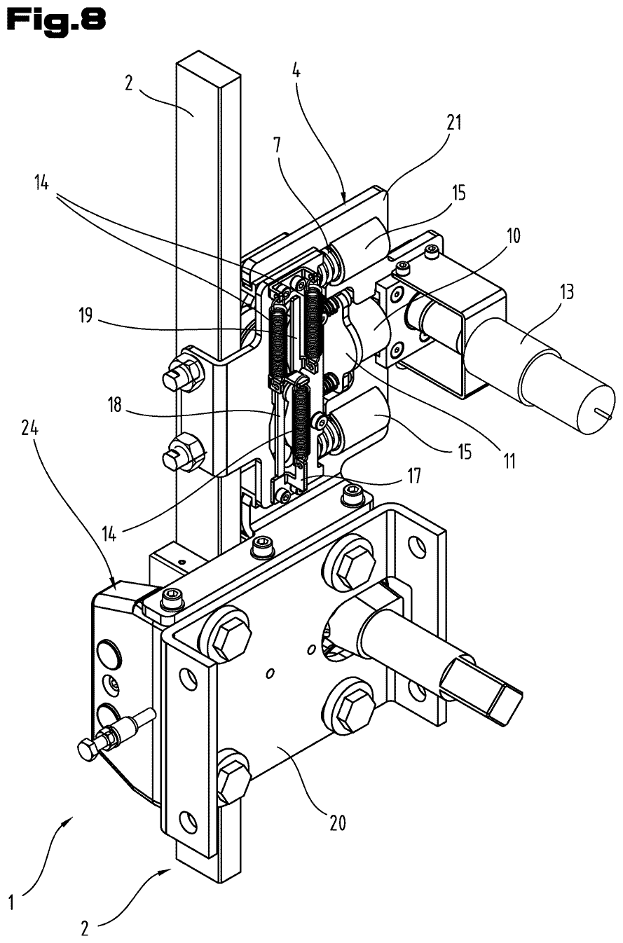

FIG. 8 shows another, somewhat modified embodiment of a safety brake device in accordance with the invention. In this version, the attachment plate 21 is not connected to the support element 20 of the catching device 1. Therefore, the attachment plate 21 is not arranged so as to be fixed relative to the rail 2 but coupled, preferably mounted so as to be fixed, to the base body 24 of the safety brake device 1 that is mounted to as to be laterally displaceable.

All operations in an emergency explained above are clearly carried out as quickly as possible, with the highest possible speed of movement of the individual components and with corresponding noise emission. Starting from the basic position with the electromagnet 10 still supplied with current in the normal operation of the conveying means and thus the actuation arrangement still held in the release position, in which also the trigger arrangement 4 remains in the release position, the safety brake device is triggered in the event of an incident, for example by a sensor arrangement 29 for the monitoring of the speed and/or the monitoring of the acceleration and/or the monitoring of the weight. Here, the application of current to the electromagnet 10 is stopped, so that the trigger element 3 is moved in a direction towards the rail 2 under the action of the compression springs 7, 8 until it finally rests against the rail 2 and enters into a frictional connection thereto. This results in the safety brake device being in the activation position. If the safety brake device is to be deactivated for reasons of energy efficiency, for example in case of a longer standstill of the conveying means and the entire plant, wherein the electromagnet 10 is switched current-free, it is desired for protection of the material and for a lower noise emission to carry out the deactivation in a gentle and quiet manner.

To that end and in accordance with the invention, it is provided that the safety brake device is equipped with a controller 28 for the trigger arrangement 4, which switches off the plant upon manual input by a user or in accordance with a specifiable schedule which is deposited in or feedable to the controller 28, moves the trigger element 3 to the trigger position while the trigger arrangement is still active and yet prevents it from springing forward to this trigger position by the force of the compression springs 7, 8. In this trigger position, the trigger element 3 is fixed so as to be in contact with the rail 2 and resting against it, typically by the effect of the compression springs 7, 8. In this position, the power supply of the trigger arrangement 4 is deactivated via the controller 28. In particular, the respective electromagnet 10 is deactivated by this current interruption, without the element that was initially held back by this being able to move further. A pushbutton, a lever, a keyboard and/or mouse 30 or similar can be connected to the controller 28 as actuating elements for deactivating the safety brake device. The sensor system can alternatively also be integrated into the controller 28 or formed by the controller 50 itself.

In order to ensure a particularly quiet switching to the deactivated state, the controller 28 for the trigger arrangement 4 is designed such that, in case of a manual input or in accordance with a specifiable schedule, the trigger element 3 is moved to the trigger position more slowly than in an emergency. To that end, the electric rotary motor 13, which acts upon the trigger element 3 in order to move it from the trigger position back to the passive position again after an emergency, is activated preferably already in the passive position and while the electromagnet 10 is still active. Preferably, the rotary motor 13 is also operated more slowly, i.e. with lower rpm, than during the return of the trigger element 3 after an emergency. Particularly simple to control and operate is an embodiment in accordance with the invention in which the rotary motor 13 is designed to move in one direction of rotation only.

For a resumption of operation of the conveying means with the safety brake device in accordance with the invention, the deactivation must either be reactivated via the operating elements 30 or the power supply of the actuation arrangement must be reactivated in accordance with the specifiable schedule, and the trigger element 3 is moved back to the passive position during this process by means of the electric motor 13 and when the electromagnet 10 is resupplied with current. Here, like after an emergency, the trigger element 3 is moved back again against the effect of the compression springs 7, 8.

Table of reference numbers

| | |
|---|---|
| 1 | safety brake device |
| 2 | rail |
| 3 | trigger element |
| 3.1 | oblong hole |
| 4 | trigger arrangement |
| 5 | roller |
| 6 | braking element |
| 7 | compression spring |
| 8 | compression spring |
| 9 | eccentric |
| 10 | electromagnet |
| 11 | coupler plate |
| 12 | counterholder |
| 12.1 | oblong hole |
| 12.2 | cover metal sheet |
| 12.3 | progressive rolling contour |
| 13 | rotary motor |
| 14 | extension spring |
| 15 | spring guide |
| 16 | spring holding element |
| 17 | spring holding element |
| 18 | retraction guide element |
| 19 | retraction guide element |
| 20 | support element |
| 21 | attachment plate |
| 24 | base body |
| 25 | engagement lever |
| 25.1 | head for downward catch |
| 25.2 | head for upward catch |
| 25.3 | disc springs |
| 26 | brake shoe |
| 27 | disc spring package |
| 28 | control |
| 29 | sensor |
| 30 | operating element |
| 31 | normal operation software module |
| 32 | deactivation software module |

1-17. (canceled)

18: A safety brake device for a conveying means, in particular for an elevator cabin and/or for a counterweight, with a support element (20) to be affixed at the conveying means at least with a brake arrangement (25, 26), with at least one brake shoe (26) affixed at the support element (20), with a braking surface extending in braking direction, which is intended to be applied at a rail (2) arranged in a stationary manner parallel to the conveying route when the safety brake device is triggered, wherein the brake shoe (26) is movable at least approximately at a right angle to the braking surface, and with a free space, which, in an installed state of the safety brake device, receives the rail (2), and with at least one engagement element (25), which is arranged on the side of the free space opposite the brake shoe (26) and is placeable between a release position and at least one brake position, wherein the shortest possible distance between the engagement element (25) and the brake shoe (26) is provided in the brake position, wherein the brake arrangement (25, 26) is designed to clamp the rail (2) received in the free space in the brake position; and with a trigger arrangement, which is connected, in terms of control engineering, to the brake arrangement (25, 26) in order to bring same to a brake position, wherein the trigger arrangement (3, 5) comprises a trigger element (3), which is displaceable parallel to the braking direction from a release position to at least one brake position and coupled to the brake arrangement (25, 26) such that same can also be brought to a brake position; and wherein the trigger arrangement has a contact element (5) which is displaceable from a release position to a first brake position maximally protruding into the free space, wherein the contact element (5) is displaceable further, essentially parallel to the braking direction to a second brake position, in which it exerts a force on the trigger element (3) in a direction towards the brake position of the trigger element (3), wherein the trigger element (3) is coupled to the engagement element (25) such that same is deflected to at least one brake position, wherein the trigger element (3) is equipped with a guide running in its longitudinal direction, preferably in the form of an oblong hole (3.1), for the contact element (5) or for the connection to the engagement element (25), and wherein an electrically triggerable actuation arrangement (7 to 19) prevents or causes the movement of the contact element (5) to the first brake position, wherein the actuator acts upon a counterholder displaceable transversely to the braking direction and in relation to the free space, which counterholder is equipped with a guide contour (12.3) for the contact element (5), wherein the guide contour (12.3) has at least one section whose distance from the rail (2) declines consistently from the release position of the contact element (5) towards the brake position and wherein a section whose distance to the rail (2) corresponds to at least that of the release position adjoins preferably from the section of the guide contour (12.3) closest to the rail (2) to the brake position.

19: The safety brake device according to claim 18, wherein the contact element (5) is configured as a roller affixed to an axle, in particular having a friction-increasing rolling circumference.

20: The safety brake device according to claim 18, wherein the contact element (5) is acted upon with a pretension force in a direction towards the free space by means of at least one actuator, and wherein the electrically activatable actuation arrangement counteracts the pretension force and holds the contact element (5) in the release position.

21: The safety brake device according to claim 18, wherein the contact element (5) is acted upon with the pretension force by means of at least one compression spring (7).

22: The safety brake device according to claim 18, wherein the actuation arrangement comprises a controllable electromagnet (10), which acts upon the contact element (5) against the pretension force when supplied with current.

23: The safety brake device according to claim 18, wherein the actuation arrangement has at least one fluidic actuator, which acts upon the contact element (5) against the pretension force via a controllable source for the working fluid.

24: The safety brake device according to claim 18, wherein, when supplied with current by means of a fluidic, electric or electromagnetic actuator, the actuation arrangement acts upon the contact element (5) with a force in a direction towards the trigger position.

25: The safety brake device according to claim 18, wherein the trigger arrangement (3, 5, 6) is positioned at a base body (24) of the brake arrangement (25, 26) and mounted so as to be displaceable transversely to the braking direction with the base body.

26: A safety brake device for a conveying means, in particular for an elevator cabin and/or for a counterweight, with
a) at least one brake arrangement (25, 26) connected to the conveying means;
b) a trigger arrangement (3, 5), which is connected, in terms of control engineering, to the brake arrangement (25, 26) in order to bring same to the brake position;
c) at least one trigger element (3), which is integrated in the trigger arrangement (3, 5) and which can optionally be placed between a trigger position and a passive position,
d) an actuator (7), which acts upon the trigger element (3) with a pretension force in a direction towards the trigger position;
further comprising
e) an electrically triggerable actuation arrangement (7 to 13) for changing the position of the trigger element (3) between passive position and trigger position, wherein the actuation arrangement, in an activated state, counteracts the pretension force and holds the trigger element (3) in the passive position, and
f) a controller (28) for the actuation arrangement (7 to 13), which is designed to move the trigger element (3) to the trigger position upon manual input or in accordance with a specifiable schedule while the actuation arrangement is active and to then deactivate the power supply of the actuation arrangement, and to subsequently reactivate the power supply of the actuation arrangement (7 to 13) until a new manual input takes place, or in accordance with the specifiable schedule, and to move the trigger element (3) to the passive position again.

27: The safety brake device according to claim 26, wherein the actuation arrangement (7 to 13) comprises a controllable electromagnet (10), which acts upon the trigger element (3) against the pretension force when supplied with current.

28: The brake catching arrangement according to claim 26, wherein the controller (28) for the actuation arrangement (7 to 13) is designed such that, in case of a manual input or in accordance with a specifiable schedule, the actuation arrangement is activated such that the trigger element (3) is moved to the trigger position more slowly than in an emergency.

29: The brake catching arrangement according to claim 26, wherein the actuation arrangement (7 to 13) has an electric rotary motor (13) which acts upon the trigger element (3) in order to move same between passive position and trigger position.

30: The brake catching arrangement according to claim 29, wherein the rotary motor (13) is designed to move in one direction of rotation only.

31: The safety brake device according to claim 29, wherein, in case of a manual input or in accordance with a specifiable schedule, the rotary motor (13) is operated with lower rpm than after an emergency.
